(19) United States
(12) Patent Application Publication
(10) Pub. No.: US 2003/0156288 A1
(43) Pub. Date: Aug. 21, 2003

(54) Sensor band for aligning an emitter and a detector

(76) Inventors: P. T. Barnum, Castalc, CA (US); Massi E. Kiani, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/078,920

(22) Filed: Feb. 20, 2002

(51) Int. Cl. G01B 11/00

(52) U.S. Cl. 356/399

(57) ABSTRACT

A device connects a light emitting device and a detector. The device includes a first securement device attached to the light emitting device, a second securement device attached to the detector, and a band having a first end connected to the first securement device and a second end connected to the second securement device. The band is made of a flexible material and is configured to align the light emitting device with the detector. The device also includes an extender attached to the first securement device and configured to wrap around the band.

### BACKGROUND OF THE INVENTION

1. Field of the Invention

The present invention relates generally to the field of sensors. More specifically, the present invention relates to a sensor band for aligning an emitter and a detector.

2. Description of the Related Art

The medical community has used a variety of medical devices to monitor the vital signs of neonates, infants, children, and adults. One of the goals of monitoring vital signs is to prevent injury to the most vital and sensitive organs, such as the brain and the heart, by detecting an unstable condition, e.g., a low blood oxygen level. Monitoring vital signs typically requires trained medical personnel to accurately and safely use and operate the medical devices on the patient. If the medical devices are incorrectly or improperly used or operated, it is likely that the medical personnel will obtain inaccurate readings or results. For example, the medical personnel may incorrectly or improperly attach the medical device to the patient's body ultimately resulting in an inaccurate blood oxygen reading.

One particular medical device used to monitor the amount of oxygen in blood is a pulse oximetry system. A typical pulse oximetry system includes a sensor attached to or positioned adjacent to a particular part of the patient's body, a monitor configured to transmit and receive signals from the sensor, and a conductor configured to connect the sensor and monitor. Conventionally, the sensor has both red and infrared LED emitters and a photodiode detector. To measure blood oxygen levels for example, the emitters and detector are typically positioned adjacent to an adult patient's finger or an infant patient's foot. When attached to the patient's finger, the emitter is positioned to project light through the fingernail and into the blood vessels and capillaries underneath. The photodiode detector is positioned adjacent to the portion of the finger opposite the fingernail so as to detect the LED emitted light as it emerges from the finger tissues.

### SUMMARY OF THE INVENTION

One drawback of conventional sensors is the difficulty in aligning the emitter and the detector. For example, when a sensor is used to monitor the amount of oxygen in blood, the emitter needs to be aligned so that the detector receives light from the emitter. Aligning the emitter with the detector is sometimes difficult because the medical personnel are unable to determine the path of the light once it leaves the emitter. Therefore, it is possible that the medical personnel might have to take several measurements to ensure the accuracy of the sensor's reading. Only after the emitter is aligned with the detector can the detector receive and accurately detect the light transmitted from the emitter.

Another drawback of conventional sensors is the detector's inability to detect a sufficient amount of light from the emitter because the distance between the emitter and detector is too large. This results in the sensor being unable to obtain a very accurate reading. Therefore, a need exists for a device that can accurately align and correctly distance the emitter with the detector.

One aspect of the present invention is a device for connecting a light emitting device to a detector. The device includes a first securement device attached to the light emitting device, a second securement device attached to the detector, and a band having a first end connected to the first securement device and a second end connected to the second securement device. The band is made of a flexible material and is configured to align the light emitting device with the detector. The device also includes an extender attached to the first securement device and configured to wrap around the band. The extender has a length L2 that is typically greater than a length L1 of the band.

Another aspect of the present invention is a sensor system having a light emitting device configured to emit light and a detector configured to detect the light and generate a current based on the amount of light detected. The sensor system also has a band having a first end configured to be connected to the light emitting device and a second end configured to be connected to the detector. The flexible material of the band allows it to be contoured around a patient's finger or other body part. One advantage of a flexible band is that it is can be contoured around various finger sizes or other body parts while still having the light emitting device aligned with the detector.

For purposes of summarizing the present invention, certain aspects, advantages and novel features of the present invention have been described herein. Of course, it is to be understood that not necessarily all such aspects, advantages or features will be embodied in any particular embodiment of the present invention.

### BRIEF DESCRIPTION OF THE DRAWINGS

A general system that implements the various features of the present invention will now be described with reference to the drawings. The drawings and the associated descriptions are provided to illustrate embodiments of the present invention and not to limit the scope of the present invention. Throughout the drawings, reference numbers are re-used to indicate correspondence between referenced elements. In addition, the first digit of each reference number indicates the figure in which the element first appears.

FIG. 1 is a perspective view of a sensor system having a band according to one aspect of the present invention;

FIG. 2 is a perspective view of a sensor system having a band positioned adjacent to a patient's finger according to one aspect of the present invention;

FIG. 3 is a top view of a sensor system having a band, a monitor, a sensor plug, and conductors according to one aspect of the present invention;

FIG. 4 is an end view of a portion of a sensor system having a band according to one aspect of the present invention;

FIG. 5 is a bottom view of a sensor system having a band according to one aspect of the present invention;

FIG. 6 is a perspective view of a sensor system having a removable band positioned adjacent to a patient's foot according to another aspect of the present invention;

FIG. 7 is a top view of a sensor system having a removable band according to another aspect of the present invention;

FIG. 8 is an end view of a portion of the sensor system having a removable band according to another aspect of the present invention;

FIG. 9 is a top view of a sensor having a perforated band according to another aspect of the present invention;

FIG. 10 is a top view of a portion of a sensor system having a perforated band according to another aspect of the present invention;

FIG. 11 is a top view of a sensor system having a light emitting device, a detector, a band, and an extender according to another aspect of the invention;

FIG. 12 is a perspective view of a sensor system, which includes a light emitting device, a detector, a first button having a base connected to the light emitting device, and a second button having a base connected to the detector; and

FIG. 13 is a side view of the sensor system of FIG. 12 attached to the patient's finger.

### DETAILED DESCRIPTION OF THE PREFERRED EMBODIMENT

The present invention has applicability in the field of medical probes and sensor systems in general. For illustrative purposes, however, the following description pertains to oximetry sensor systems. To facilitate a complete understanding of the present invention, the remainder of the detailed description describes the present invention with reference to the drawings, wherein like reference numbers are referenced with like numerals throughout.

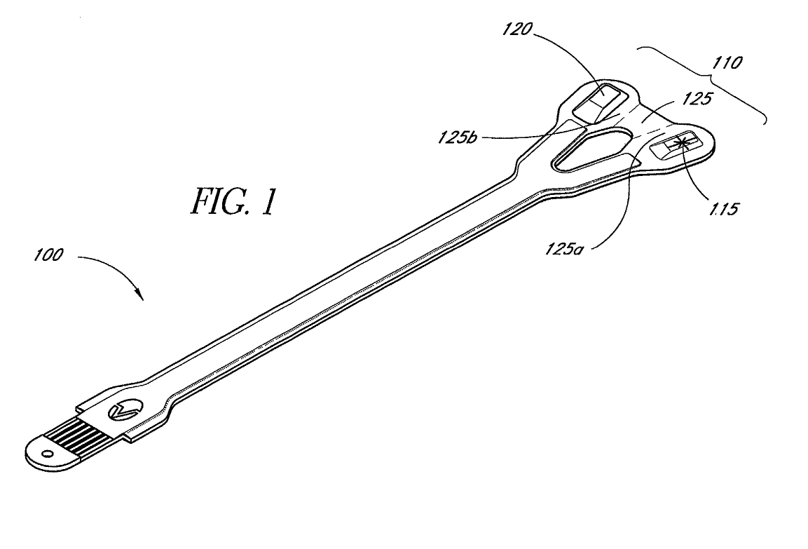

FIG. 1 is a perspective view of a sensor system 100 that is capable of monitoring physiological parameters of the patient. For example, the sensor system 100 can be configured to determine or monitor a patient's heartbeat, blood pressure, blood gas saturation (such as oxygen saturation), blood constituents, heart rate, respiration rate, and depth of anesthesia. In addition, other types of monitoring include measuring the pressure and quantity of a substance within the body, cardiac output, venous oxygen saturation, arterial oxygen saturation, total hemoglobin, blood alcohol level, drugs, cholesterol, glucose, protein, carbon dioxide, carbon monoxide, and other in-vivo measurements. Hence, medical personnel can use the sensor system 100 as a noninvasive way of measuring various physiological parameters.

The sensor system 100 includes a sensor 110 having a light emitting device 115 (also known as a light-emitting diode or LED), e.g., an emitter, configured to emit light and a detector 120, e.g., a photodiode detector, configured to detect the light and generate a current based on the amount of light detected. Typically, the current generated by the detector 120 is proportional to the intensity of the light detected. The sensor system 100 further includes a band 125 having a first end 125a configured to be connected to the light emitting device 115 and a second end 125b configured to be connected to the detector 120. The band 125 can also be referred to as a bridge, a connector or a device capable of attaching two or more elements or objects and can be used with and attached to any type of sensor such as a gap sensor, a Y-shaped sensor or an L-shaped sensor.

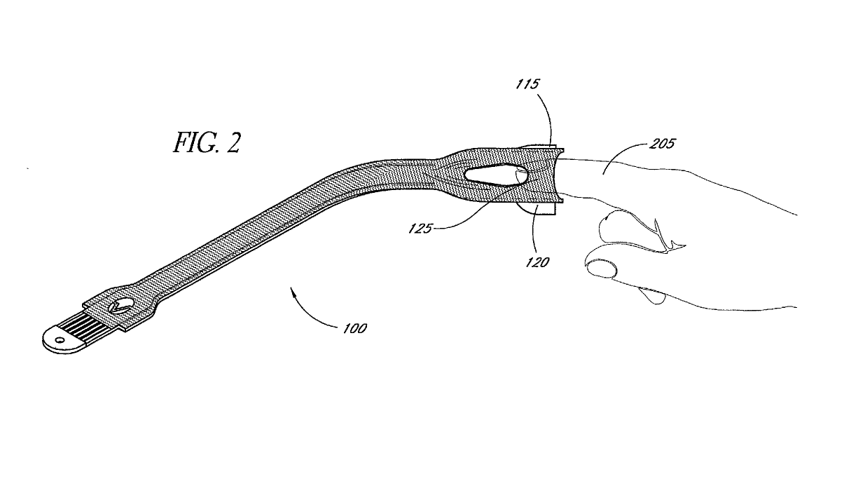

FIG. 2 is a perspective view of the sensor system 100 positioned adjacent to a patient's finger 205. The light emitting device 115 emits light at a predefined wavelength through a particular medium, e.g., the patient's finger 205, and the light is attenuated as it propagates through the medium. Once the attenuated light reaches the detector 120, the intensity of the attenuated light is measured. When the detector 120 is positioned too far from the light emitting device 115, the detector 120 is unable to obtain an accurate intensity reading, which causes the sensor system 100 to return an inaccurate result or no result at all. To ensure that the sensor system 100 obtains accurate results, the light emitting device 115 and the detector 120 should be positioned no greater than a maximum distance apart from one another. Further details regarding the light emitting device 115 and the detector 120 are described in, for example, U.S. Pat. No. 5,632,272 to Diab, et al., entitled “Signal Processing Apparatus,” and U.S. Pat. No. 5,758,644 to Diab, et al., entitled “Manual and Automatic Probe Calibration,” which are both assigned to the assignee of the present invention. The disclosures of both patents are incorporated by reference herein.

The band 125 is used to align the light emitting device 115 with the detector 120 so that the detector 120 receives light from the light emitting device 115. For example, to monitor a physiological parameter of the patient, the band 125 is attached to the patient's body so that the light emitting device 115 and the detector 120 are aligned with one another. The sensor 110 is aligned when the light emitting device 115 and the detector 120 are positioned such that the light from the light emitting device 115 travels along an axis that intersects the detector 120. The band 125 greatly improves the alignment by ensuring that both the light emitting device 115 and the detector 120 are the same distance away from the distal end of the patient's finger or other body part. Hence, the left-right and front-back alignments are improved using the band 125. The amount of light received by the detector 120 is enhanced when using the band 125 because the band 125 provides a means for accurately aligning and positioning the light emitting device 115 and the detector 120. The band 125 also increases the amount of surface area that comes into contact with the patient's body, thus making it easier to align and position the band 125 adjacent to the patient's body or contoured with the patient's body part. Accordingly, the band 125 enhances the accuracy of the sensor system 100 by providing a sensor 110 that can be aligned and attached to a patient's finger or other body part in an accurate and efficient manner.

In addition, the band 125 simplifies the attachment of the sensor 110 by allowing medical personnel to use one hand to attach the sensor 110 to the patient's body. For example, using the index finger to position the light emitting device 115 and the thumb to position the detector 120, the medical personnel is able to use one hand to attach the sensor 110 to the patient's body. This allows the medical personnel to hold and position the monitoring site while attaching the sensor 110 to the patient's body.

The band 125 is preferably made of a flexible material that can be contoured around a patient's finger or other body part. In one embodiment, the band 125 is made of the same adhesive tape material as the sensor. Alternatively, the band 125 can made of a semi-rigid plastic material that is configured and sized to fit the patient's finger or other body part.

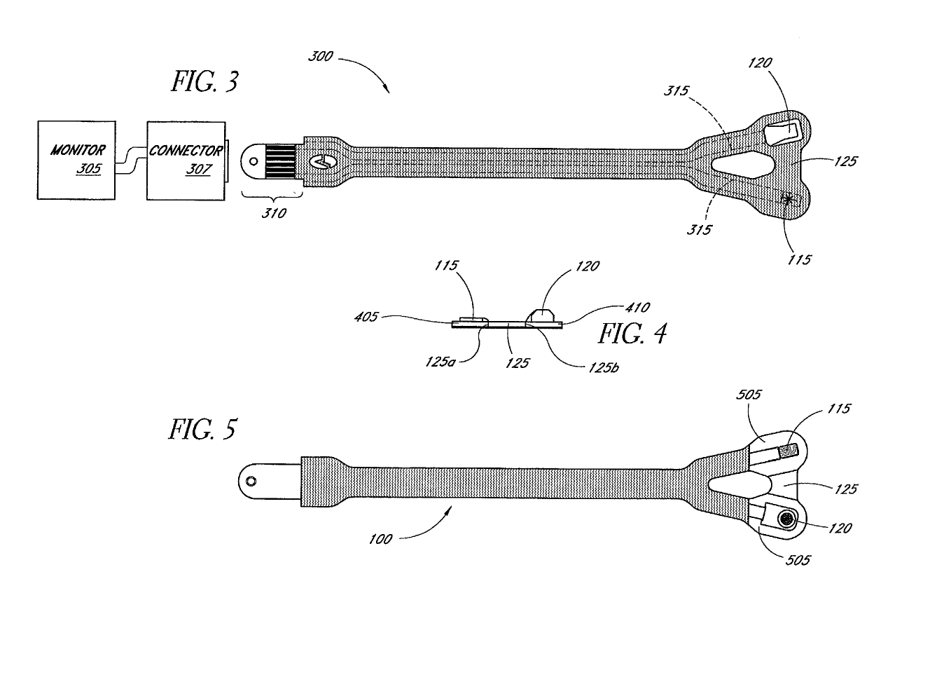

FIG. 3 is a top view of a sensor system 300, which further includes a monitor 305, a connector 307 configured to be connected to the monitor 305, a sensor plug 310 configured to be connected to the connector 307, and conductors 315 configured to connect the light emitting device 115 and the detector 120 to the sensor plug 310. The monitor 305 activates the light emitting device 115 and measures the current generated by the detector 120. The monitor 305 includes circuitry for controlling the sensor 110, processing sensor signals, determining physiological parameters of a patient using the information received from the sensor signals and the current generated by the detector 120, and displaying the physiological parameters. The conductors 315 relay information, e.g., an emitter drive current, from the monitor 305 to the light emitting device 115 and, e.g., a signal, from the detector 120 to the monitor 305. The conductors 315 are generally covered using the same material as the band 125. Further details regarding the monitor 305, sensor plug 310, and conductors 315 are described in U.S. Pat. No. 6,165,005 to Mills, et al., entitled “Patient Cable Sensor Switch,” which is assigned to the assignee of the present invention. Further details regarding the connector 307 is described in, for example, U.S. Pat. No. 6,152,754 to Gerhardt, et al., entitled “Circuit Board Based Cable Connector,” which is assigned to the assignee of the present invention. The disclosure of the Gerhardt, et al. patent is incorporated by reference herein.

FIG. 4 is an end view of a portion of the sensor system 100 having the band 125. In one embodiment, the first end 125a of the band 125 is connected to a first securement device 405 and the second end 125b of the band 125 is connected to a second securement device 410. The first and second securement devices 405, 410 are attached to the light emitting device 115 and the detector 120, respectively, to hold the light emitting device 115 and the detector 120 in place. The first and second securement devices 405, 410 can be made of a plastic, an adhesive or any other material capable of holding, securing or attaching to an element or object, and are typically made of the same or similar material as the band 125. In one embodiment, the band 125 and the first and second securement devices 405, 410 are integrally formed using one piece of material. The band 125, the first and second securement devices 405, 410 can be made of one or more pieces of material so that the light emitting device 115 and the detector 120 are sandwiched between the material, which holds the light emitting device 115 and the detector 120 in place.

The band 125 can be configured and sized to ensure that the light emitting device 115 and the detector 120 are not spaced beyond their range of operation. For example, if the range of operation of the light emitting device 115 and the detector 120 is two inches, the band 125 is sized so that the light emitting device 115 and the detector 120 can be no more than two inches apart. The range of operation is generally defined as the maximum distance between the light emitting device 115 and the detector 120 that results in an accurate measurement and operation of the sensor 110. Each different type of sensor 110 may have a different range of operation, and therefore the band 125 may be configured and sized to be no greater than the range of operation of the light emitting device 115 and the detector 120.

The band 125 can also be configured and sized for particular applications of the sensor 110 or in accordance with the patient's needs. That is, different types of sensors can have different types of bands. For example, if a patient's oxygen saturation is to be measured by using the patient's finger, the band is configured and sized to fit partially or completely around the patient's finger. Similarly, if the sensor system 100 is to be used on a patient's foot to measure blood pressure, the band 125 is configured and sized to fit the patient's foot. The band 125 can be configured and sized to take measurement from different body parts, e.g., finger, hand, foot, ear, nose, forehead, etc. A combination of the range of operation, the particular applications or other criteria desired by the patient and medical personnel can be used to configure and size the band 125.

FIG. 5 is a bottom view of the sensor system 100 having the band 125. To aid in the attachment of the sensor 110 to the patient's body, the portions of the sensor system 100 that contact the patient's body are often coated with an adhesive material 505, which is capable of sticking to the patient's body. The sensor 110 can be attached to the patient's body by removing adhesive protectors (not shown) that are attached to the adhesive material 505 and then pressing the light emitting device 115 and the detector 120 against the patient's body.

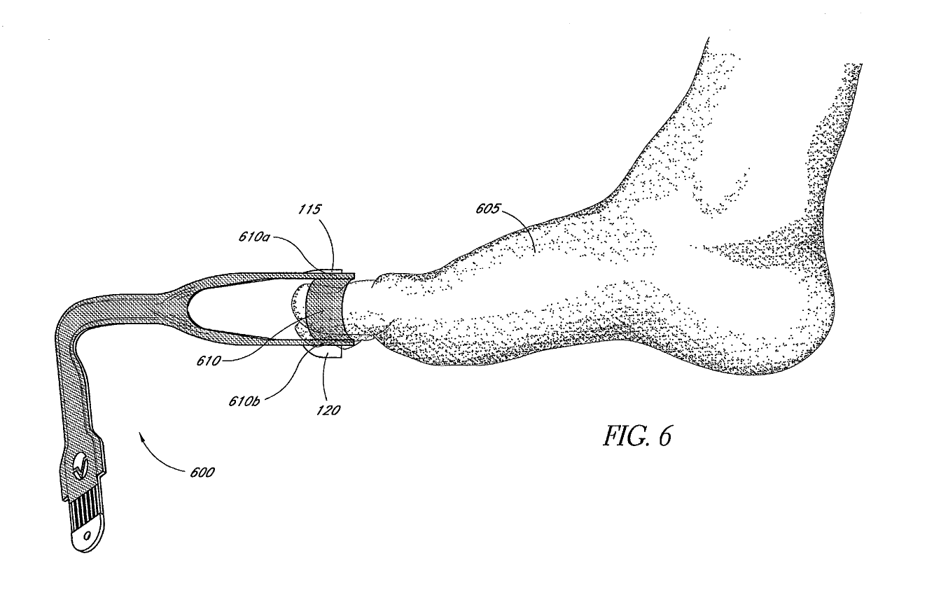

FIG. 6 is a perspective view of a sensor system 600 positioned adjacent to a patient's foot 605 to monitor physiological parameters of the patient. The sensor system 600 includes the light emitting device 115, the detector 120, and a removable band 610, which has a first end 610a and a second end 610b. The band 610 can be attached to and detached from the sensor 110 at the first and second ends 610a, 610b. Various attachment means include Velcro, tape, buttons, or any other adhesive material. The band 610 is configured to be removable from the sensor 110 for situations when the light emitting device 115 and the detector 120 need to have a non-standard alignment or when the additional contact surface area created by the band 610 is not desired. For example, a patient having a foot with a steep sloping top surface might need to have a non-standard alignment of the light emitting device 115 and the detector 120. The band 610 is configured and sized to be larger than the band 125 for attachment to larger body parts, such as the patient's foot 605. Other features and elements of the band 610 are similar to those described above for the band 125.

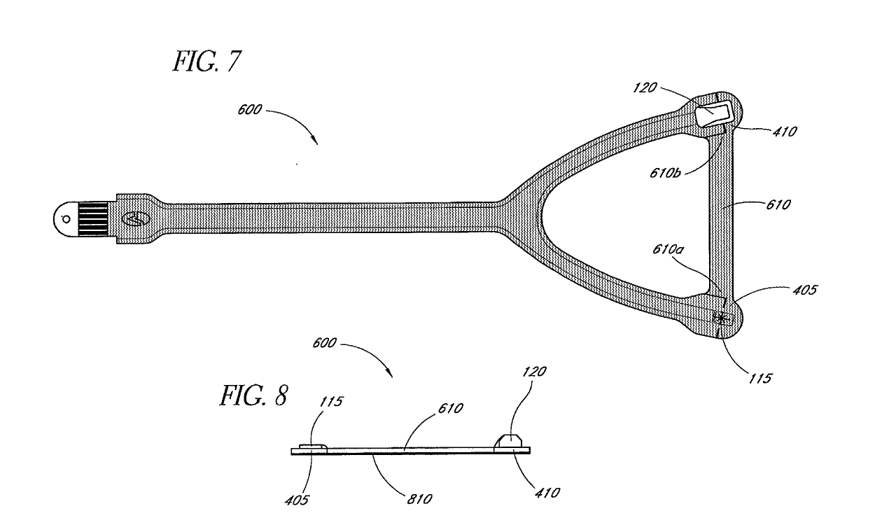

FIG. 7 is a top view and FIG. 8 is an end view of the sensor system 600 having the removable band 610. The first end 610a of the removable band 610 can be attached directly to the light emitting device 115 or can be connected to the first securement device 405. Similarly, the second end 610b of the removable band can be attached directly to the detector 120 or can be connected to the second securement device 410. In one embodiment, the first and second securement devices 405, 410 are attached to the band 610 using a hook and loop fastening material 810 (e.g., Velcro®) (FIG. 8). Hence, the band 610 can be adjustable. Even though the fastening material 810 has been described as a means of attaching the band 610 to the first and second securement devices 405, 410, other means are known to those of ordinary skill in the art and are within the spirit and scope of the present invention.

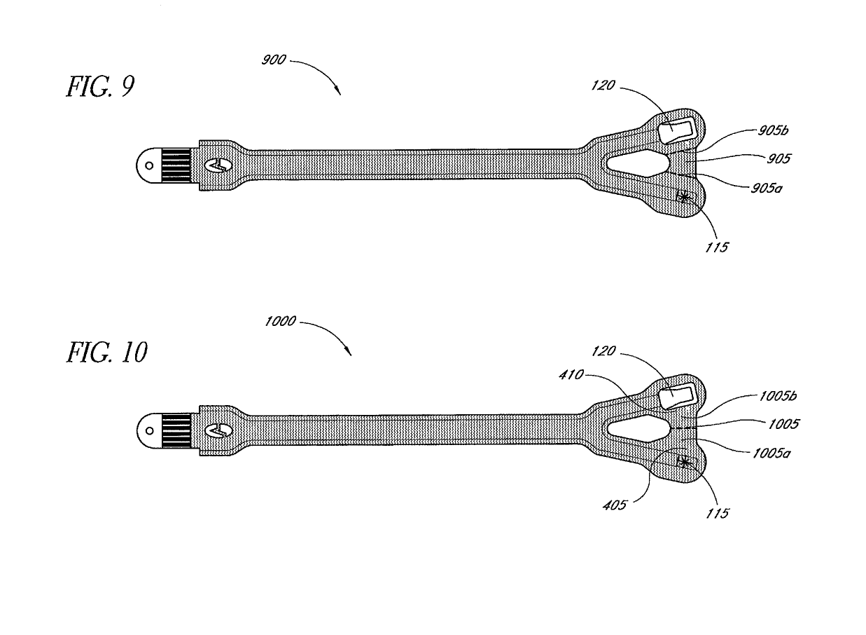

FIG. 9 is a top view of a sensor system 900 having a band 905, which includes a first end 905a and a second end 905b. The first end 905a can be attached directly to the light emitting device 115 or can be connected to the first securement device 405. Similarly, the second end 905b can be attached directly to the detector 120 or can be connected to the second securement device 410. In one embodiment, the band 905 is perforated (shown by the dashed lines) near the first and second ends 905a, 905b to allow medical personnel to remove or tear the band 905 if desired. The band 905 is preferably made of a cardboard material or a tape material so that it can be easily and quickly removed by tearing the band 905 along the perforated lines. Alternatively, the band 905 can be made of the same adhesive tape material as the sensor system 900.

FIG. 10 is a top view of a sensor system 1000 having a band 1005, which includes a first end 1005a and a second end 1005b. The first end 1005a can be attached directly to the light emitting device 115 or can be connected to the first securement device 405. Similarly, the second end 1005b can be attached directly to the detector 120 or can be connected to the second securement device 410. In one embodiment, the middle of the band 1005 is perforated along a line 1010 to allow the light emitting device 115 to be positioned without being restricted by the positioning and location of the detector 120. The band 1005 is preferably made of a cardboard material so that it can be easily and quickly removed by tearing the band 1005 along the perforated line. Alternatively, the band 1005 can be made of the same adhesive tape material as the sensor system 1000.

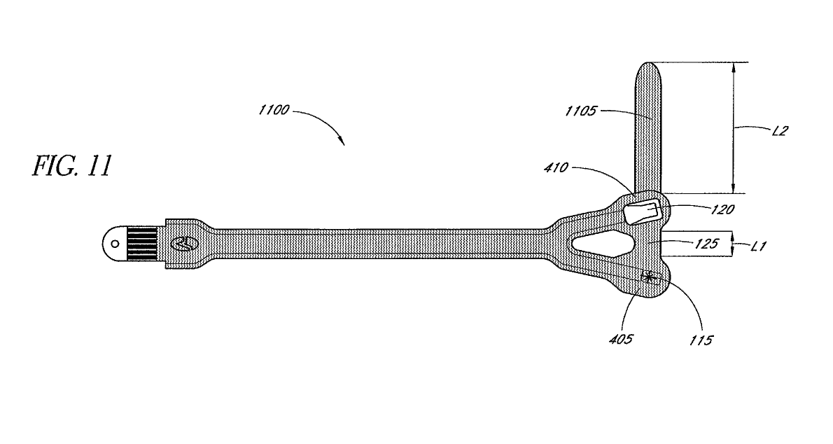

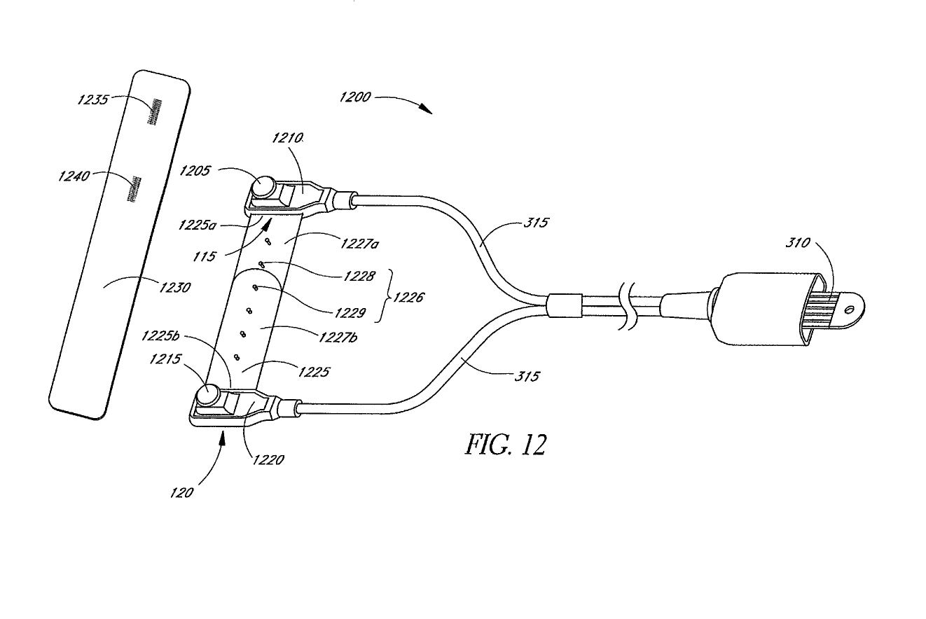

FIG. 11 is a top view of a sensor system 1100 having the light emitting device 115, the detector 120, the band 125, and an extender 1105. The extender 1105 can be attached to a number of different elements. For example, the extender 1105 can be attached at one end to the light emitting device 115, at the detector 120, at the first securement device 405, at the second securement device 410 or at the band 125. The other end of the extender 1105 is free from attachment. In FIG. 11, the extender 1105 is attached to the second securement device 410. The extender 1105 creates an L-shaped device, and hence the sensor system 1100 is optionally referred to as an L-shaped sensor.

The extender 1105 can be wrapped around the patient's finger to help hold the sensor 110 in place by taking the free or loose end of the extender 1105 and wrapping it around the patient's finger or other body part. The extender 1105 is optionally referred to as a wrap, a cover or a device that facilitates in the securement of the sensor 110 to the patient's finger or other body part. The extender 1105 has a length L2 that is greater than a length L1 of the band 125. In one embodiment, the length L1 is approximately 1 centimeter and the length L2 is approximately 5 centimeters. The greater length L2 of the extender 1105 allows the medical personnel to wrap the extender 1105 around the patient's body part several times. The extender 1105 is typically made of the same material as the band 125. In one embodiment, the extender 1105 is made of a soft cotton material or a plastic fabric material.

FIG. 12 is a perspective view of a sensor system 1200, which includes a light emitting device 115, a detector 120, a first button 1205 having a base 1210 attached to the light emitting device 115, and a second button 1215 having a base 1220 attached to the detector 120. The sensor system 1200 can be reuseable. The sensor system 1200 also includes a band 1225 having a first end 1225a configured to connect the base 1210 of the first button 1205 and a second end 1225b configured to connect to the base 1220 of the second button 1215. The band 1225 is removably attached at the first and second ends 1225a, 1225b. The band 1225 includes an adjustment device 1226 (e.g., Velcro®), which allows the band 1225 to be increased and decreased in size. Preferably, the band 1225 has two pieces, a first piece 1227a having pegs 1228 and a second piece 1227b having openings 1229, for allowing the medical personnel to adjust the size of the band for each particular patient's body part and for each particular application. To attach the second piece 1227b to the first piece 1227a, the openings 1229 are placed over the pegs 1228 at the desired band size. To detach the second piece 1227b from the first piece 1227a, the second piece 1227b is pulled apart from the first piece 1227a. Hence, the band 1225 can be adjustable in a manner similar to the band of a baseball cap. Even though pegs 1228 and openings 1229 have been described as a means of adjusting the size of the band 1225, other means are known to those of ordinary skill in the art and are within the spirit and scope of the present invention.

A wrap 1230 having two openings 1235, 1240 can be used to further secure the sensor 110 to the patient's finger or other body part. For example, the first opening 1235 can be placed over the first button 1205 and the second opening 1240 can be placed over the second button 1215 to further secure the light emitting device 115 to the detector 120. The remaining part of the wrap 1230 can be wound around the patient's finger for additional securement. In one embodiment, the wrap 1230 is made of a soft cotton material or a plastic foam tape material.

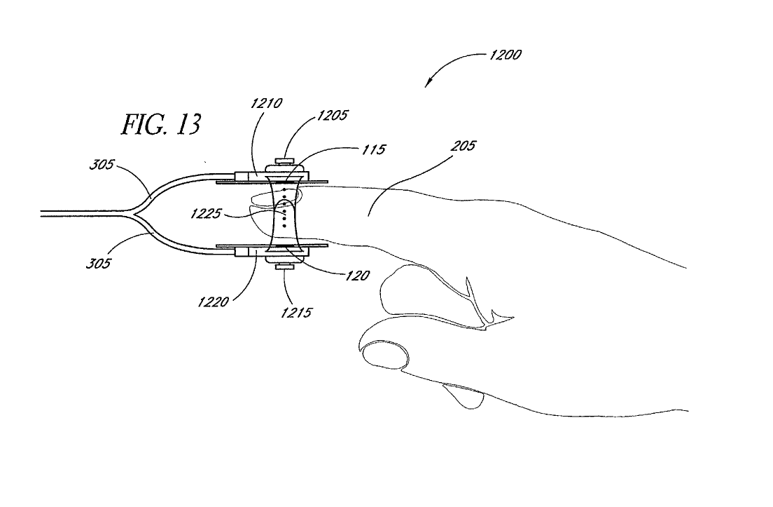

FIG. 13 is a side view of the sensor system 1200 attached to the patient's finger 205. As shown, the band 1225 holds the light emitting device 115 and the detector 120 in position to simplify and maintain the accuracy of the alignment. The band 1225 is connected to the base 1210 of the first button 1205 and to the base 1220 of the second button 1215. To secure the wrap to the sensor system 1200, the first opening 1235 of the wrap 1230 is placed over the first button 1205, the wrap is pulled around the patient's finger 205, and then the second opening 1240 is placed over the second button 1215. This further secures the light emitting device 115 to the detector 120. The remaining part of the wrap 1230 is then wound around the patient's finger for additional securement.

The sensor system has been disclosed in detail in connection with various embodiments of the present invention. Although the foregoing invention has been described in terms of certain preferred embodiments, other embodiments will be apparent to those of ordinary skill in the art from the disclosure herein. For example, the band can be configured in a variety of shapes and sizes while still maintaining the spirit and scope of the present invention. Additionally, other combinations, omissions, substitutions and modifications will be apparent to the skilled artisan in view of the disclosure herein. Accordingly, the present invention is not intended to be limited by the preferred embodiments, but is to be defined by reference to the appended claims.

Additionally, all publications, patents, and patent applications mentioned in this specification are herein incorporated by reference to the same extent as if each individual publication, patent, or patent application was specifically and individually indicated to be incorporated by reference.

What is claimed is:

1. A sensor system comprising:
a light emitting device configured to emit light;
a first securement device attached to the light emitting device;
a detector configured to detect the light received from the light emitting device and generate a current based on the amount of light detected;
a second securement device attached to the detector; and
an adjustable band having a first end connected to the first securement device and a second end connected to the second securement device, the band configured to align the light emitting device and the detector.

2. The sensor system of claim 1 wherein the adjustable band is a two piece adjustable band, a first piece of the adjustable band having means for attaching to a second piece of the adjustable band.

3. The sensor system of claim 1 wherein the adjustable band has a first piece having a plurality of pegs and a second piece having a plurality of openings, the plurality of pegs configured to be removably attached to the plurality of openings to allow the adjustable band to be increased and decreased in size.

4. The sensor system of claim 1 further comprising an extender having a first end attached to the first securement device and a second end free from attachment and configured to be wrapped around the adjustable band.

5. The sensor system of claim 1 further comprising a first button attached to the first securement device and a second button attached to the second securement device.

6. The sensor system of claim 5 further comprising a wrap having at least two openings, the first opening configured to attach to the first button and the second opening configured to attach to the second button.

7. A device for connecting a light emitting device and a detector, the device comprising:
a first securement device attached to the light emitting device;
a second securement device attached to the detector; and
a band having a first end connected to the first securement device and a second end connected to the second securement device, the band configured to align the light emitting device with the detector.

8. The device of claim 7 further comprising an extender having a first end attached to the first securement device and a second end free from attachment and configured to be wrapped around the band.

9. The device of claim 8 wherein the band has a first length and the extender has a second length, the second length being greater than the first length.

10. The device of claim 7 further comprising a first button attached to the first securement device and a second button attached to the second securement device.

11. The device of claim 10 further comprising a wrap having at least two openings, the first opening configured to attach to the first button and the second opening configured to attach to the second button.

12. The device of claim 7 wherein the first end of the band is detachable from the first securement device.

13. The device of claim 7 wherein the second end of the band is detachable from the second securement device.

14. The device of claim 7 wherein the band is perforated at the first and second ends for removal of the band.

15. The device of claim 7 wherein the band has a perforation that is located in a middle section of the band.

16. A sensor system comprising:
a light emitting device configured to emit light;
a detector configured to detect the light and generate a current based on the amount of light detected; and
a two-piece adjustable band having a first end configured to be connected to the light emitting device and a second end configured to be connected to the detector.

17. The device of claim 16 further comprising an extender having a first end attached to the first securement device and a second end free from attachment and configured to be wrapped around the adjustable band.

18. The device of claim 16 further comprising a first button attached to the first securement device and a second button attached to the second securement device.

19. The device of claim 18 further comprising a wrap having at least two openings, the first opening configured to attach to the first button and the second opening configured to attach to the second button.

20. The sensor system of claim 16 wherein the first end of the band is configured to be attached to and detached from the second end of the band.

21. The sensor system of claim 16 wherein the two-piece adjustable band has a first piece having a plurality of pegs and a second piece having a plurality of openings, the plurality of pegs configured to be removably attached to the plurality of openings to allow the adjustable band to be increased and decreased in size.
